(19) United States
(12) Patent Application Publication
(10) Pub. No.: US 2016/0085402 A1
(43) Pub. Date: Mar. 24, 2016

(54) INFORMATION PROCESSING DEVICE

(71) Applicant: SHARP KABUSHIKI KAISHA, Osaka-shi, Osaka (JP)

(72) Inventor: Taisuke HARA, Osaka-shi (JP)

(21) Appl. No.: 14/889,227

(22) PCT Filed: Jun. 3, 2014
(86) PCT No.: PCT/JP2014/064747

§ 371 Date: Nov. 5, 2015

(30) Foreign Application Priority Data
Jun. 26, 2013 (JP) 2013-134106

(51) Int. Cl. G06F 3/0485; G06F 3/16; G06F 3/0484; G06F 3/0488; G06F 3/0486

(52) U.S. Cl. CPC G06F 3/0485; G06F 3/0488; G06F 3/0486; G06F 3/04847; G06F 3/165

(57) ABSTRACT

An information processing device (1) includes: a seek control section (12) for, in a case where a locator and a fine adjustment frame each for changing a playback position are displayed at an identical position on a seek bar, causing the locator and the fine adjustment frame to be displayed so that an operation is carried out with respect to each of the locator and the fine adjustment frame: and a data stream playback section (13) for changing, in accordance with an operation to move the fine adjustment frame, the playback position by a change amount smaller than a change amount that is obtained in a case where the locator is moved by a moving amount by which the fine adjustment frame is moved.

### TECHNICAL FIELD

The present invention relates to a user interface for specifying an output position in an information processing device for outputting data located at a specific position in content.

### BACKGROUND ART

Concerning an information processing device for playing back content such as a moving image and music, there have been conventionally proposed various user interfaces for allowing a user to control an operation to play back the content. A particularly widely used user interface is a user interface for displaying an object indicative of a playback position of content (such an object is hereinafter referred to as a locator) on a time axis corresponding to a playback time of the content (such a time axis is hereinafter referred to as a seek bar). The user can specify the playback position of the content by an operation to move a position of the locator on the seek bar (a seek operation).

However, according to such an arrangement, it may be difficult to finely adjust the playback position of the content. This is because a length of the seek bar is fixed (or the length, which may change, is limited to a size of a display screen), whereas a length of a data stream changes in accordance with the content. Such a problem is particularly remarkable in a touch panel. The following description specifically discusses the problem with reference to FIG. 5, which shows a conventional technique.

FIG. 5 illustrates a state in which a seek operation is carried out with respect to a display screen 300 of a touch panel. The display screen 300 illustrated in FIG. 5 displays thereon a seek bar 100 having a seek bar length of 100 mm and a locator 110. On the display screen 300, content having a data stream length of 1000 seconds is played back. That is, in a case where the locator 110 is moved on the seek bar 100 by 1 mm, a playback position of the content is moved by an amount equivalent to 10 seconds.

Note here that the touch panel has a limit accuracy with which the touch panel can detect an operation. For example, in a case where the touch panel of FIG. 5 has a limit accuracy of 5 mm, a user cannot specify the playback position with an accuracy of a playback time of less than 50 seconds which playback time is equivalent to a seek operation of less than 5 mm. Such a playback time equivalent to the limit accuracy is made longer in proportion to the data stream length of the content. Examples of a technique which has attempted to solve the problem include techniques of the following Patent Literatures 1 to 3. Patent Literature 1 discloses a technique for displaying a time axis indicative of a vicinity of a current playback position in response to pressing of a button. Further, Patent Literatures 2 and 3 also disclose techniques similar to the technique of Patent Literature 1.

### CITATION LIST

### Patent Literature

### [Patent Literature 1]

Japanese Patent Application Publication, Tokukai, No. 2008-33743 (Publication Date: Feb. 14, 2008)

### [Patent Literature 2]

Japanese Patent Application Publication, Tokukai, No. 2012-44474 (Publication Date: Mar. 1, 2012)

### [Patent Literature 3]

Japanese Patent Application Publication, Tokukai, No. 2009-295147 (Publication Date: Dec. 17, 2009)

### SUMMARY OF INVENTION

### Technical Problem

However, the techniques of Patent Literatures 1 to 3 each require, prior to fine adjustment of a playback position, a given operation to switch one mode to another mode in which to finely adjust the playback position. For example, the technique of Patent Literature 1 requires an operation to press a button. Such an operation forces a user to bear an unnecessary burden. Further, in response to such an operation, complicated control needs to be carried out for switching one mode to another mode in which to finely adjust the playback position. Note that occurrence of such a problem is shared by a technique for changing a playback position and a technique for changing an output position (e.g., a display position) of content by moving an object on a reference axis.

The present invention has been made in view of the problems, and an object of the present invention is to provide an information processing device and the like capable of promptly finely adjusting an output position of content.

### Solution to Problem

In order to attain the object, an information processing device in accordance with a first aspect of the present invention for changing an output position of content by a change amount in accordance with a moving amount by which a first object indicative of the output position of the content is moved on a reference axis which serves as a reference for determining the output position of the content, the information processing device includes: a display control section for (i) causing a second object for changing the output position of the content to be displayed on the reference axis, and (ii) in a case where the first object and the second object are displayed at an identical position, causing the first object and the second object to be displayed so that an operation is carried out with respect to each of the first object and the second object; and an output control section for changing, in accordance with a moving amount by which the second object is moved on the reference axis, the output position of the content by a change amount smaller than a change amount that is obtained in a case where the first object is moved by the moving amount by which the second object is moved.

### Advantageous Effects of Invention

An aspect of the present invention makes it possible to promptly finely adjust an output position of content.

### BRIEF DESCRIPTION OF DRAWINGS

FIG. 1 is a block diagram illustrating a substantial part of an information processing device in accordance with an embodiment of the present invention.

(a) of FIG. 2 illustrates a display screen of the information processing device. (b) of FIG. 2 illustrates the display screen in which a fine adjustment frame is dragged. (c) of FIG. 2 illustrates the display screen in which a locator is dragged.

(a) of FIG. 3 illustrates the display screen in which the fine adjustment frame is moved to an end of a seek bar. (b) of FIG. 3 illustrates the display screen in which a finger is moved off the fine adjustment frame after the fine adjustment frame is dragged.

FIG. 4 is a flow chart showing an example of a process carried out by the information processing device.

FIG. 5, which shows a conventional technique, illustrates a problem that is caused by a seek operation carried out with respect to a conventional information processing device.

### DESCRIPTION OF EMBODIMENTS

### Embodiment 1

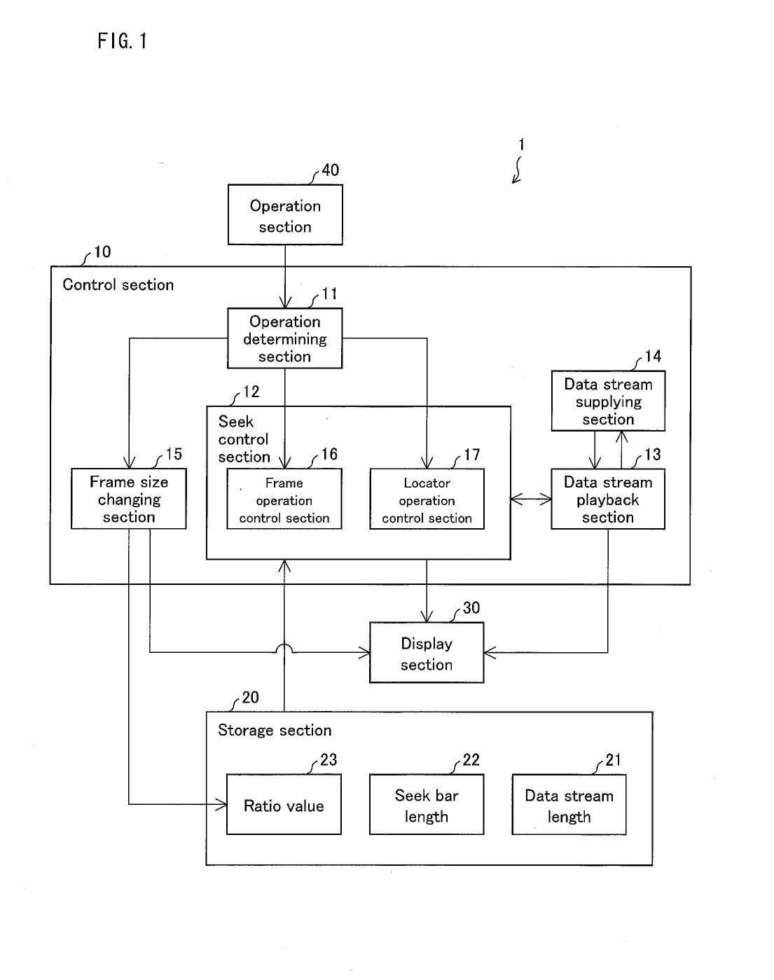

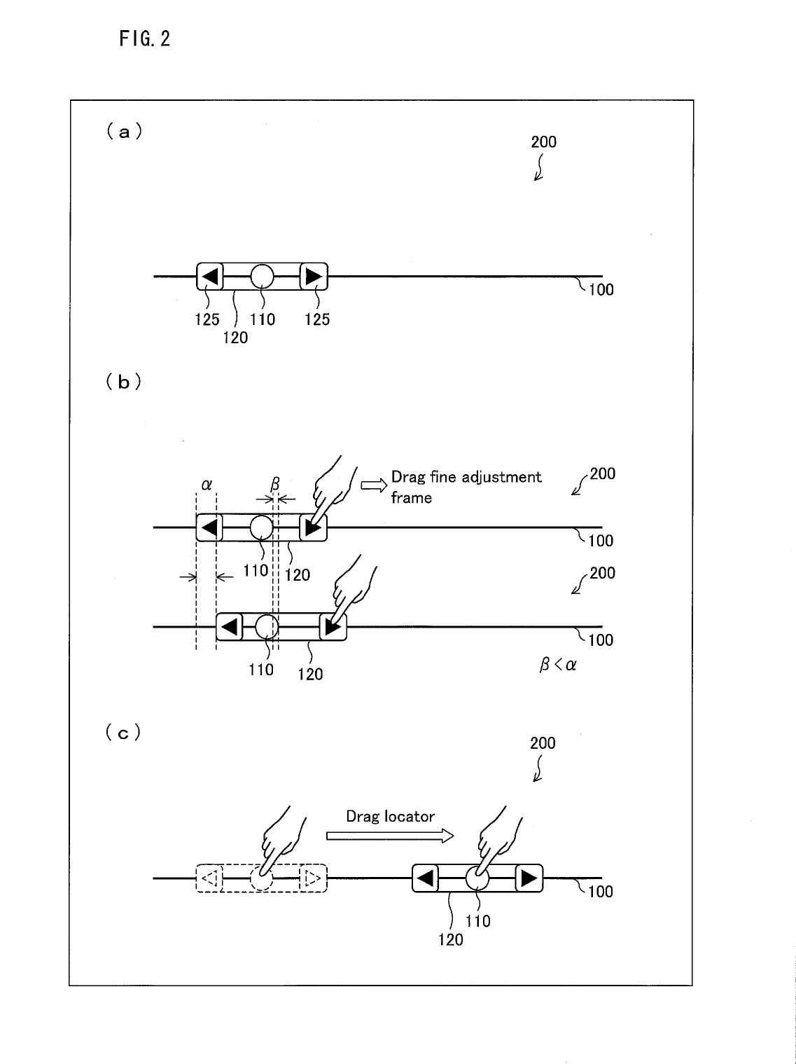

An embodiment of the present invention is described below with reference to FIGS. 1 to 4.

<<Outline of Operation>>

The following description discusses, with reference to FIG. 2, an outline of an operation of an information processing device 1 in accordance with Embodiment 1. The information processing device 1 is an electronic device capable of playing back (outputting) content such as a moving image and music. Further, the information processing device 1 includes a touch panel and has a function of receiving an operation of a user by displaying, on the touch panel, a user interface for changing a playback position of the content.

The following description discusses the outline of the operation of the information processing device 1. (a) of FIG. 2 illustrates a display screen 200 of the information processing device 1. As illustrated in (a) of FIG. 2, the display screen 200 displays thereon a seek bar (time axis) 100, a locator (first object) 110, and a fine adjustment frame (second object) 120 together.

The seek bar (reference axis) 100 is a time axis indicative of a playback time of the entire content. The seek bar 100 has a left end that is a position of a start of the content and a right end that is a position of an end of the content. The seek bar 100 serves as a reference for determining a playback position of the content. On the seek bar 100, the locator 110 and the fine adjustment frame 120 are displayed.

The locator 110 is an object indicative of a current playback position (output position) of the content. The locator 110 moves on the seek bar 100 in tandem with the playback position of the content. In response to playback of the content at the start of the content, the locator 110 starts moving from the left end of the seek bar 100 in a rightward direction in (a) of FIG. 2. Then, in response to playback of the end of the content, the locator 110 stops moving at the right end of the seek bar 100.

In response to an instruction that is given by a user operation to change the playback position, the locator 110 moves to the changed playback position. Examples of such an operation to change the playback position (hereinafter referred to as a seek operation) include (i) an operation in which a user touches the locator 110 so as to move the locator 110 to a desired playback position by a drag operation, and (ii) an operation in which the user touches, with a finger thereof, a desired playback position on the seek bar 100. Such a seek operation changes not only a displayed playback position but also an actual playback position of the content to a playback position corresponding to a position of the locator 110 on the seek bar 100.

The information processing device 1 not only has such a conventional function as described earlier, but also has a main feature of displaying the fine adjustment frame 120. The fine adjustment frame 120 is an object having a frame having a rectangular shape. Further, the fine adjustment frame 120 has, at right and left ends inside of the frame, drag direction display regions 125 each having a square shape. The drag direction display regions 125 each have a figure (triangle) that is drawn so as to indicate that the fine adjustment frame 120 can be dragged in a direction along the seek bar 100 (a drag direction).

(b) of FIG. 2 illustrates the display screen 200 in which a drag operation is carried out with respect to the fine adjustment frame 120. In response to a start of the drag operation by a touch of the fine adjustment frame 120 with a finger, the fine adjustment frame 120 moves on the seek bar 100 in accordance with a drag amount α (mm) thereof and a drag direction thereof (a leftward or rightward direction in (b) of FIG. 2). Concurrently with this, the locator 110 is moved by a moving amount β (note, however, that β<α) in the drag direction of the fine adjustment frame 120. Further, an actual playback position of the content is also changed to a position corresponding to a position of the locator 110.

That is, though the locator 110 and the fine adjustment frame 120 are each capable of changing the playback position by moving on the seek bar 100, the fine adjustment frame 120 is smaller than the locator 110 in amount of change in the playback position in a case where the locator 110 and the fine adjustment frame 120 are moved by an equal moving amount. In other words, the fine adjustment frame 120 is smaller than the locator 110 in amount of change in the playback position per unit moving distance. Thus, in a case where the user moves the fine adjustment frame 120, the locator 110 moves a distance shorter than a distance that the fine adjustment frame 120 moves. This allows the user to more precisely specify the playback position of the content by operation of the fine adjustment frame 120 than by operation of the locator 110. For example, it is possible to carry out a seek whose amount is smaller than a minimum moving amount by which a displayed position of the locator 110 can change. In other words, even in a case where the fine adjustment frame 120 is moved to a degree that the displayed position of the locator 110 does not change at all, the playback position of the content is actually changed.

Furthermore, the fine adjustment frame 120 has been continuously displayed on the seek bar 100 since the seek bar 100 started to be displayed. This does not require a procedure, which has been necessary in a conventional technique, for switching one mode to another mode in which to finely adjust the playback position.

Note that the fine adjustment frame 120 which is not touched with the finger of the user moves in tandem with the locator 110 which is located at a center of the fine adjustment frame 120. Note also that, as illustrated in (c) of FIG. 2, the fine adjustment frame 120 also follows the locator 110 which is dragged by the user.

The following description refers to, as a normal seek process, a process, carried out by the information processing device 1, for changing the playback position in accordance with the drag operation with respect to the locater 110. Meanwhile, the following description refers to, as a fine adjustment seek process, a process for changing the playback position in accordance with the drag operation with respect to the fine adjustment frame 120. The normal seek process and the fine adjustment seek process each can be carried out either during stop of playback of the content or during playback of the content.

Note that it is possible to display, in response to a touch of the fine adjustment frame 120 with a finger, a scale or the like serving as a criterion for determining how far the locator 110 is to move by a drag movement of the fine adjustment frame 120. It is also possible to switch between a display and a non-display of the scale or the like in accordance with a user operation.

Furthermore, a shape of the fine adjustment frame 120 is not limited to that illustrated in (a) of FIG. 2. Alternatively, the fine adjustment frame 120 can have another shape provided that the another shape allows the drag operation to be carried out with respect to either one of the locator 110 and the fine adjustment frame 120 which are displayed at an identical position. That is, the locator 110 and the fine adjustment frame 120 which are displayed by superimposition each only need to have a shape and a size each of which prevents one of the locator 110 and the fine adjustment frame 120 from completely covering the other of the locator 110 and the fine adjustment frame 120, and at least a part of one of the locator 110 and the fine adjustment frame 120 which one is superimposed on the other of the locator 110 and the fine adjustment frame 120 only needs to be exposed. Further, it is not always necessary to locate the fine adjustment frame 120 so that the locator 110 is located at the center of the fine adjustment frame 120. For example, the fine adjustment frame 120 can be located near the locator 110, e.g., at a position on an outer circumference of the locator 110.

<<Arrangement of Substantial Part>>

Next, an arrangement of the information processing device 1 is described below with reference to FIG. 1. FIG. 1 is a block diagram illustrating a substantial part of the information processing device 1. Note that FIG. 1 does not illustrate an arrangement(s) which is(are) not directly related to a feature(s) of the invention.

As illustrated in FIG. 1, the information processing device 1 includes a control section 10, a storage section 20, a display section 30, and an operation section 40. The operation section 40 and the display section 30 have an input surface and a display surface, respectively, which are integrally formed as a touch panel. Note that it is possible to widely use, as the information processing device 1, devices each having a function of playing back content, such as a mobile phone, a smart phone, a tablet PC, an audio player, and a game machine.

The storage section 20, which is constituted by a nonvolatile storage device, stores therein a data stream length 21, a seek bar length 22, and a ratio value 23. The data stream length 21, which is information indicative of a playback time of an entire data stream of content read by the information processing device 1, has a unit of, for example, a second. The seek bar length 22, which is information indicative of a total length of the seek bar 100, has a unit of, for example, a millimeter. The ratio value 23, which is information referred to during the fine adjustment seek process, refers to a ratio between the drag amount α of the fine adjustment frame 120 and the moving amount β of the locator 110. The ratio value 23 is a value of α assuming that β has a value of 1. The ratio value 23 can be freely set by a user or can be set in advance during production of the information processing device 1. Further, the ratio value 23 can be constant regardless of the data stream length 21, or can change in accordance with the data stream length 21.

The display section 30 displays, for example, information and an image in accordance with control by the control section 10. The operation section 40 receives a touch input made by an indicator such as a finger or a stylus. Specifically, the operation section 40 which has sensed a touch to the input surface supplies coordinates of a position of the touch to the control section 10.

The control section 10 integrally controls the information processing device 1. The control section 10 includes an operation determining section 11, a seek control section (display control section) 12, a data stream playback section (output control section) 13, a data stream supplying section 14, and a frame size changing section 15. The seek control section 12 includes a frame operation control section 16 and a locator operation control section 17.

The operation determining section 11 detects a drag operation with respect to each of the locator 110 and the fine adjustment frame 120. Specifically, in a case where coordinates of a touch start position which coordinates have been supplied from the operation section 40 are outside a coordinate range of the locator 110 and within a coordinate range of the fine adjustment frame 120, the operation determining section 11 determines that the drag operation with respect to the fine adjustment frame 120 has been started. The operation determining section 11 supplies, to the frame operation control section 16, (i) the drag amount α, which is an amount of movement of the fine adjustment frame 120 on the seek bar 100 due to the drag operation, and (ii) the drag direction, which is a moving direction in which the fine adjustment frame 120 is moved due to the drag operation. Meanwhile, in a case where the coordinates of the touch start position are within the coordinate range of the locator 110, the operation determining section 11 determines that the drag operation with respect to the locator 110 has been started, and supplies the drag amount of the locator 110 and the drag direction of the locator 110 to the locator operation control section 17.

The seek control section 12 updates the display screen 200 in accordance with the drag operation with respect to the locator 110 or the fine adjustment frame 120, and instructs the data stream playback section 13 to carry out a seek process. The frame operation control section 16 or the locator operation control section 17 is in charge of specifically carrying out a process of the seek control section 12.

The frame operation control section 16 is started by being triggered by an input from the operation determining section 11 of the drag amount α of the fine adjustment frame 120 and the drag direction of the fine adjustment frame 120. First, the frame operation control section 16 reads out the ratio value 23 from the storage section 20, and the moving amount β is calculated by dividing the drag amount α by the ratio value 23. Next, the frame operation control section 16 moves the fine adjustment frame 120 in the drag direction by the drag amount α, and moves the locator 110 in the drag direction by the moving amount β.

Next, the frame operation control section 16 reads out the data stream length 21 and the seek bar length 22 from the storage section 20, and calculates a seek amount based on the following equation (1).

Seek amount=data stream length 21×(moving amount β of locator/seek bar length 22) (1)

Then, the frame operation control section 16 supplies the calculated seek amount and the drag direction to the data stream playback section 13.

The locator operation control section 17 is started by being triggered by an input from the operation determining section 11 of the drag amount and the drag direction of the locator 110. First, the locator operation control section 17 moves each of the locator 110 and the fine adjustment section 120 by the drag amount in the drag direction. Further, the locator operation control section 17 reads out the data stream length 21 and the seek bar length 22 from the storage section 20, and calculates a seek amount based on the following equation (2).

Seek amount=data stream length 21×(drag amount of locator/seek bar length 22) (2)

Then, the locator operation control section 17 supplies the calculated seek amount and the drag direction to the data stream playback section 13.

As described earlier, according to the seek control section 12, a change in amount of a playback position with respect to the moving amount of the fine adjustment frame 120 is smaller than a change in amount of a playback position with respect to the moving amount of the locator 110.

The data stream playback section 13, which controls playback of content, is started by being triggered by an input of the seek amount and the drag amount from the frame operation control section 16 or the locator operation control section 17. Specifically, the data stream playback section 13 requests, from the data stream supplying section 14, a data stream part of content to be played back in which data stream part a playback position has been changed by the seek amount in the drag direction. Then, the data stream playback section 13 plays back the data stream part supplied from the data stream supplying section 14, and transfers a moving image of the data stream part to the display section 30, which displays the transferred moving image. As described earlier, in response to the request by the data stream playback section 13, the data stream supplying section 14 supplies the data stream part of the content to be played back.

<<Other Operations of Fine Adjustment Frame 120>>

Next, the following description discusses, with reference to (a) of FIG. 3, a range in which the fine adjustment frame 120 is movable. (a) of FIG. 3 illustrates a state in which the fine adjustment frame 120 is dragged to a position distant from the locator 110. As illustrated in (a) of FIG. 3, the fine adjustment frame 120 can be endlessly moved alone to any place on the seek bar 100 by the drag operation. Even in the case where the fine adjustment frame 120 is moved for a long distance, the moving amount β of the locator 110 is calculated in accordance with the drag amount α and the ratio value 23.

Next, the following description discusses, with reference to (b) of FIG. 3, an operation which is carried out when a finger is moved off the fine adjustment frame 120. As illustrated in (b) of FIG. 3, when the finger is moved off the touch panel in the middle of dragging of the fine adjustment frame 120, the state of the fine adjustment frame 120 returns to a state in which the locator 110 is located at the center of the fine adjustment frame 120. That is, when an operation to move the fine adjustment frame 120 is finished, the fine adjustment frame 120 is moved to a position at which the locator 110 is located.

Specifically, in the case where the finger is moved off the touch panel, the operation determining section 11 provides the frame operation control section 16 with information indicating that a touch has been cancelled. The frame operation control section 16 which has received the information changes the drag amount α of the fine adjustment frame 120 to 0 mm and stops the seek process. Then, the frame operation control section 16 moves a display position of the fine adjustment frame 120 to a current position of the locator 110 (i.e., a position corresponding to a changed playback position of the content).

With this, even in a case where a user drags the fine adjustment frame 120 to an end of the seek bar 100, at which end there is no space to further move the fine adjustment frame 120, the fine adjustment frame 120 returns to its original position when the finger is moved off the fine adjustment frame 120. This makes it possible to continuously finely adjust the playback position.

<<Flow of Process>>

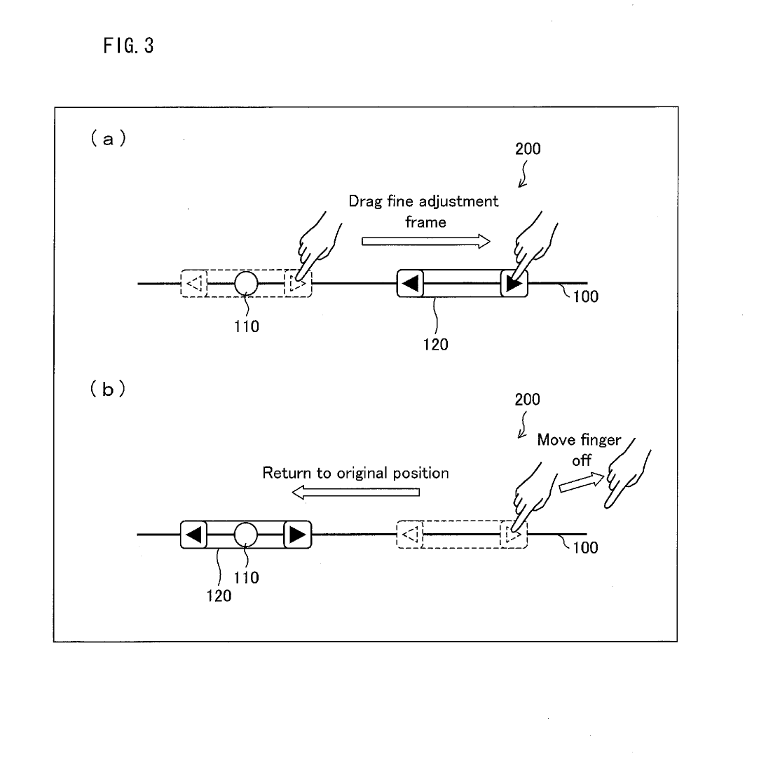

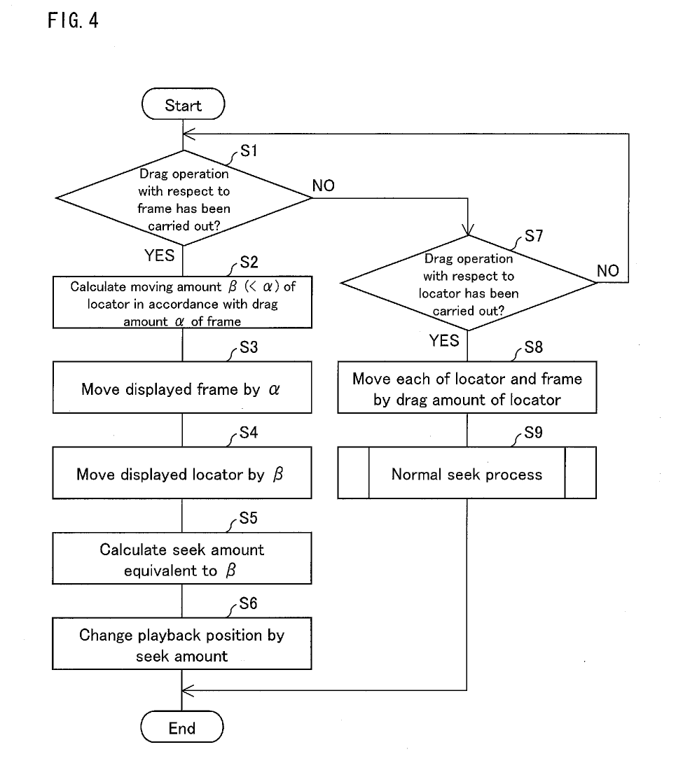

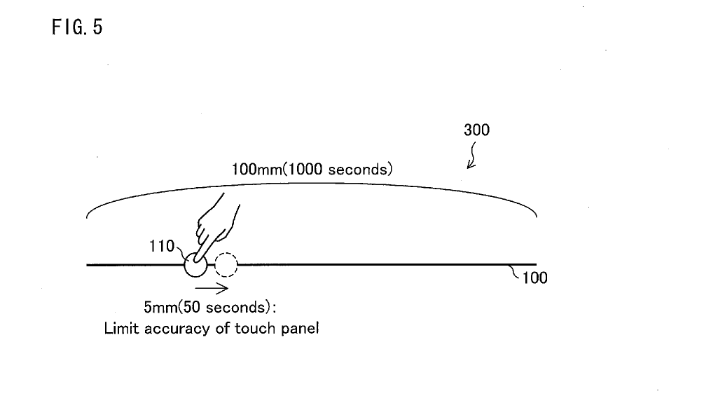

Next, the following description discusses, with reference to FIG. 4, a flow of a process carried out by the information processing device 1. FIG. 4 is a flow chart showing an example of the process carried out by the information processing device 1. In FIG. 4, the fine adjustment frame 120 is simply described as a “frame” for simplification of description.

The following description assumes that the ratio value 23 is “20” (i.e., β:α=1:20). The following description also assumes that a touch panel capable of detecting an operation of a minimum of 5 mm is used as the operation section 40.

First, in response to a given operation that is carried out with respect to the operation section 40 and triggers a start of playback or reading of content, the operation determining section 11 provides the seek control section 12 with an instruction to display the seek bar 100, the locator 110, and the fine adjustment frame 120 (not illustrated in FIG. 4). Then, in accordance with the instruction, the seek control section 12 causes the display section 30 to display the seek bar 100, the locator 110, and the fine adjustment frame 120 (a display controlling step). In this case, as illustrated in (a) of FIG. 2, the seek control section 12 causes the locator 110 and the fine adjustment frame 120 to be displayed so that the locator 110 and the fine adjustment frame 120 are located at an identical position.

In the process, in response to a touch to the input surface of the operation section 40 with a user's finger, the operation determining section 11 determines whether or not a drag operation with respect to the fine adjustment section 120 has been carried out (S1). In a case where the drag operation with respect to the fine adjustment frame 120 has been carried out (Yes at S1), the operation determining section 11 supplies the drag amount α of the fine adjustment section 120 and the drag direction of the fine adjustment section 120 to the frame operation control section 16.

Assume here that the user's finger with which the fine adjustment frame 120 has been touched is moved by 40 mm in an end direction of the seek bar 100. In this case, the operation determining section 11 outputs “40 mm” as the drag amount α and an “end direction” as the drag direction.

The frame operation control section 16 calculates the moving amount β in accordance with the ratio value 23 and the drag amount α (S2). As described earlier at the beginning of <<Flow of Process>>, since the ratio value 23 is set at “20”, the moving amount β is calculated as follows: “β=α/20=40/20=2 (mm)”

The frame operation control section 16 moves the fine adjustment frame 120 by the drag amount α (40 mm) in the drag direction (end direction) (S3), and moves the locator 110 by the moving amount β (2 mm) in the drag direction (end direction) (S4).

The frame operation control section 16 reads out the seek bar length 22 and the data stream length 21 from the storage section 20 and calculates a seek amount of the content which seek amount is equivalent to the moving amount β (2 mm) (S5). The following description assumes that the data stream length 21 is 1000 seconds and the seek bar length 22 is 100 mm. The frame operation control section 16 calculates the seek amount based on the equation (1) as follows: “seek amount=data stream length 21×(β/seek bar length 22)=1000×(2/100)=20 (seconds)” The calculated seek amount is 1/20 of a seek amount that is obtained in a case where the locator 110 is moved by an amount by which the fine adjustment frame 120 is moved. The frame operation control section 16 supplies the calculated seek amount (20 seconds) and the drag direction (end direction) to the data stream playback section 13.

The data stream playback section 13 requests the data stream supplying section 14 to supply a data stream part of content to be played back which data stream part is 20 seconds ahead of a current playback position. Then, the data stream playback section 13 plays back the data stream part which is 20 seconds ahead of the current playback position and which has been supplied from the data stream supplying section 14, and transfers the data stream part to the display section 30 in a form of a moving image (S6, an output control step). This causes the display section 30 to display, from a point in time at which the fine adjustment section 120 was operated, the content in which the playback position has been changed by 20 seconds.

In the case described earlier, a seek of 2 mm (equivalent to 20 seconds) falling below 5 mm (equivalent to 50 seconds), which is the limit accuracy of the touch panel, is carried out. As described above, use of the fine adjustment frame 120 enables a precise seek with higher accuracy than the limit accuracy with which the touch panel can detect an operation.

Meanwhile, in a case where no drag operation with respect to the fine adjustment frame 120 is carried out (No at S1), and a drag operation with respect to the locator 110 is carried out (Yes at S7), the operation determining section 11 supplies a drag amount of the locator 110 and a drag direction of the locator 110 to the locator operation control section 17.

Assume here that the user's finger with which the locator 110 has been touched is moved by 40 mm in the end direction of the seek bar 100. In this case, the operation determining section 11 outputs “40 mm” as the drag amount and the “end direction” as the drag direction. The locator operation control section 17 moves each of the fine adjustment frame 120 and the locator 110 by the drag amount (40 mm) in the drag direction (end direction) in the display section 30 (S8).

Thereafter, the normal seek process is carried out (S9). That is, the locator operation control section 17 calculates a seek amount based on the equation (2) as follows: “seek amount=data stream length 21×(drag amount/seek bar length 22)=1000×(40/100)=400 (seconds)” Then, the locator operation control section 17 supplies the calculated seek amount (400 seconds) and the drag direction (end direction) to the data stream playback section 13. A subsequent process is identical to the process of S6. As described above, movement of the locator 110 on the seek bar 100 causes the normal seek process to be carried out.

### Embodiment 2

The following description discusses another embodiment of the present invention. Note that for convenience, members having functions to those of the respective members described in Embodiment 1 are given respective identical reference numerals, and a description of those members is omitted here.

According to Embodiment 2, an operation determining section 11 detects a pinch-in operation and a pinch-out operation each carried out in a transverse direction of a user (a direction extending along a seek bar 100) with respect to an input surface of an operation section 40. The pinch-in operation refers to an operation to bring two fingers, with which the input surface is being touched, closer to each other. Meanwhile, the pinch-out operation refers to an operation to move the two fingers, with which the input surface is being touched, away from each other. The following description refers to, as a pinch-in amount, an amount indicating how short a distance between the two fingers is made by the pinch-in operation, and refers to, as a pinch-out amount, an amount indicating how long a distance between the two fingers is made by the pinch-out operation.

The operation determining section 11 which has detected the pinch-in operation supplies, to a frame size changing section 15, a pinch-in amount obtained by the pinch-in operation. Meanwhile, the operation determining section 11 which has detected the pinch-out operation supplies, to the frame size changing section 15, a pinch-out amount obtained by the pinch-out operation.

The frame size changing section 15 changes a size of a fine adjustment frame 120 in a display section 30 and sets a ratio value 23 of a storage section 20 again. Specifically, the frame size changing section 15 which has received the pinch-in amount reduces a width of the fine adjustment frame 120 in accordance with the pinch-in amount and decreases the ratio value 23 of the storage section 20 in accordance with the pinch-in amount. Meanwhile, the frame size changing section 15 which has received the pinch-out amount expands the width of the fine adjustment frame 120 in accordance with the pinch-out amount and increases the ratio value 23 of the storage section 20 in accordance with the pinch-out amount.

Assume, for example, that, in a state in which the ratio value 23 is set at a value of “20”, the user carries out the pinch-out operation, so that the width of the fine adjustment frame 120 is made twice as long as an initial value thereof. In this case, the ratio value 23 is set again at a value (40), which is twice the original value (20) thereof. That is, β:α is changed from 1:20 to 1:40 by a user operation. A longer width of the fine adjustment frame 120 thus reduces a moving amount β of a locator 110 with respect to a drag amount α of the fine adjustment frame 120. As described earlier, Embodiment 2 allows a change in the ratio value 23 by a simple operation by the user.

Note that the ratio value 23 can be arranged to gradually change in accordance with the width of the fine adjustment frame 120. Further, the fine adjustment frame 120 and the locator 110 can be integrally displayed when the width of the fine adjustment frame 120 is reduced and then reaches a width of the locator 110. Further, during such an integral display, a seek amount derived from the fine adjustment frame 120 and a seek amount derived from the locator 110 can be set to be equal to each other (where ratio value=1).

### Modified Example

The embodiments described earlier each discuss a user interface for finely adjusting a playback position of content. Note, however, that the present invention is applicable to user interfaces in general each for changing an output position of content. For example, the present invention is applicable to a scroll bar which changes a browsing position (or an edition position) and which is used in a case where an object to be displayed (e.g., a still image such as a document, a web page, or a map) lies off a screen. In such a case, the information processing device 1 displays, on a scroll bar (reference axis), a scroll box (first object) and a fine adjustment frame (second object) together each for moving the browsing position. This allows a user to promptly finely adjust the browsing position with use of the fine adjustment frame.

### Embodiment 3

### Software Implementation Example

Control blocks of the information processing device 1 (particularly, blocks of the control section 10) may be realized by a logic circuit (hardware) provided in an integrated circuit (IC chip) or the like or may be alternatively realized by software as executed by a CPU (Central Processing Unit).

In the latter case, the information processing device 1 includes: a CPU that executes instructions of a program that is software realizing the foregoing functions; ROM (Read Only Memory) or a storage device (each referred to as “storage medium”) storing the program and various kinds of data in such a form that they are readable by a computer (or a CPU); and RAM (Random Access Memory) that develops the program in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be made available to the computer via any transmission medium (such as a communication network and a broadcast wave) which enables transmission of the program. Note that the present invention can also be implemented by the program in the form of a computer data signal embedded in a carrier wave which is embodied by electronic transmission.

### CONCLUSION

An information processing device (1) in accordance with a first aspect of the present invention for changing an output position of content by a change amount in accordance with a moving amount by which a first object (locator 110, scroll box) indicative of the output position of the content is moved on a reference axis (seek bar 100, scroll bar) which serves as a reference for determining the output position of the content, the information processing device includes: a display control section (seek control section 12) for (i) causing a second object (fine adjustment frame 120) for changing the output position of the content to be displayed on the reference axis, and (ii) in a case where the first object and the second object are displayed at an identical position, causing the first object and the second object to be displayed so that an operation is carried out with respect to each of the first object and the second object; and an output control section (data stream playback section 13) for changing, in accordance with a moving amount by which the second object is moved on the reference axis, the output position of the content by a change amount smaller than a change amount that is obtained in a case where the first object is moved by the moving amount by which the second object is moved.

According to the arrangement, the output position of the content is changed, in accordance with an operation to move the second object on the reference axis, by the change amount smaller than the change amount that is obtained in a case where the first object is moved by the moving amount by which the second object is moved. That is, it is possible to finely adjust the output position of the content by operating the second object.

Further, according to the arrangement, in a case where the first object and the second object are displayed at the identical position, the first object and the second object are displayed so that an operation is carried out with respect to each of the first object and the second object. This makes it possible to operate both the first object and the second object at all times. Thus, it is unnecessary to provide a mode in which to finely adjust the output position, and it is naturally unnecessary to carry out a complicated operation such as mode switching. Further, since objects to be operated are displayed at all times, it is easy to intuitively understand an operation method for finely adjusting the output position. This brings about an effect of promptly finely adjusting the output position of the content.

In a second aspect of the present invention, an information processing device can be arranged such that, in the first aspect of the present invention, when the output position of the content is changed in accordance with an operation to move the second object, the display control section moves the first object to a position indicative of the output position thus changed.

According to the arrangement, when the output position of the content is changed in accordance with the operation to move the second object, the first object is moved to the position indicative of the output position thus changed. That is, also in a case where the output position is changed by operating not the first object but the second object, the first object is moved so as to indicate the output position of the content. This allows a user to promptly recognize the output position by a position on the reference axis at which position the first object is displayed in response to fine adjustment to the output position of the content. Further, it is also possible to immediately start adjusting the output position with use of the first object.

In a third aspect of the present invention, an information processing device can be arranged such that, in the first or second aspect of the present invention, after finishing the operation to move the second object, the display control section moves the second object to a position at which the first object is located.

According to the arrangement, after the operation to move the second object is finished, a display position of the second object is moved to a position at which the first object is located. This allows a finger to move at minimum so as to change an object to be operated. That is, it is possible to smoothly adjust the output position with use of both the first object and the second object.

Note that it is desirable that, also after an operation to move the first object is finished, the display position of the second object be moved to the position at which the first object is located. This allows the user to, for example, after roughly specifying the output position of the content by operating the first object, finely adjust the output position of the content by operating the second position while hardly moving the finger.

In a fourth aspect of the present invention, an information processing device can be arranged such that, in any one of the first through third aspects of the present invention, the display control section causes the second object to be displayed, the second object being shaped to surround the first object.

According to the arrangement, the second object is shaped to surround the first object. This allows an operation to be carried out with respect to each of the first object and the second object that are displayed at an identical position.

A control program in accordance with a fifth aspect of the present invention for causing a computer to function as an information processing device for changing an output position of content by a change amount in accordance with a moving amount by which a first object indicative of the output position of the content is moved on a reference axis which serves as a reference for determining the output position of the content, the control program causes the computer to execute: a display control step of (i) causing a second object for changing the output position of the content to be displayed on the reference axis, and (ii) in a case where the first object and the second object are displayed at an identical position, causing the first object and the second object to be displayed so that an operation is carried out with respect to each of the first object and the second object; and an output control step of changing, in accordance with a moving amount by which the second object is moved on the reference axis, the output position of the content by a change amount smaller than a change amount that is obtained in a case where the first object is moved by the moving amount by which the second object is moved. The arrangement brings about an effect similar to an effect brought about by the information processing device. Further, a computer-readable storage medium in which the control program is stored is also encompassed in the present invention.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention can be suitably used in an electronic device for outputting content.

### REFERENCE SIGNS LIST

1 Information processing device
12 Seek control section (display control section)
13 Data stream playback section (output control section)

1. An information processing device for changing an output position of content by a change amount in accordance with a moving amount by which a first object indicative of the output position of the content is moved on a reference axis which serves as a reference for determining the output position of the content,
said information processing device comprising:
a display control section for (i) causing a second object for changing the output position of the content to be displayed on the reference axis, and (ii) in a case where the first object and the second object are displayed at an identical position, causing the first object and the second object to be displayed so that an operation is carried out with respect to each of the first object and the second object; and
an output control section for changing, in accordance with a moving amount by which the second object is moved on the reference axis, the output position of the content by a change amount smaller than a change amount that is obtained in a case where the first object is moved by the moving amount by which the second object is moved.

2. The information processing device as set forth in claim 1, wherein, when the output position of the content is changed in accordance with an operation to move the second object, the display control section moves the first object to a position indicative of the output position thus changed.

3. The information processing device as set forth in claim 1, wherein, after finishing the operation to move the second object, the display control section moves the second object to a position at which the first object is located.

4. The information processing device as set forth in claim 1, wherein the display control section causes the second object to be displayed, the second object being shaped to surround the first object.

5. (canceled)
